(19) United States
(12) Patent Application Publication
(10) Pub. No.: US 2006/0197334 A1
(43) Pub. Date: Sep. 7, 2006

(54) Method of providing cooling fan for displaying an individual fan's object of devotion

(76) Inventor: Leo P. Shea, Quincy, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/361,516

(22) Filed: Feb. 24, 2006

Related U.S. Application Data
(60) Provisional application No. 60/656,190, filed on Feb. 25, 2005.

(51) Int. Cl. B42D 15/00

(52) U.S. Cl. 283/67

(57) ABSTRACT

A method for providing cooling fans for displaying an individual fan's object of devotion. A database contains a plurality of images depicting objects of devotion, such as names, logos, or other images. At least one image is selected from the database of images and printed on an adhesive-backed substrate. The adhesive-backed substrate is affixed to a cooling fan in one or more suitable image-receiving areas, such as the fan's base or the central area of the fan's protective grill

### CROSS REFERENCE TO RELATED APPLICATIONS

This application claims the benefit under 35 U.S.C. § 119(e) of U.S. Provisional Patent Application No. 60/656,190, filed on Feb. 25, 2005, the disclosure of which is incorporated by reference herein.

### STATEMENT REGARDING FEDERALLY SPONSORED RESEARCH OR DEVELOPMENT

N/A

### BACKGROUND OF THE INVENTION

A fan is a device for producing a current of air, such as for cooling a person. One form of fan is shaped like a segment of a circle and is composed of materials, such as feathers or paper, mounted on thin rods or slats and movable about a pivot so that the device may be closing compactly when not is use. Another form of fan is a device that includes a series of vanes radiating from a hub rotated on its axle by a motor.

Another type of fan is an enthusiastic devotee, such as of a sport or a performing art, usually as a spectator, or an ardent admirer or enthusiast, such as of a celebrity or a pursuit.

### SUMMARY OF THE INVENTION

The present invention relates to a method for providing cooling fans for displaying an individual fan's object of devotion or admiration. The cooling fan includes an image-receiving area where a label or decal of the object of the fan's devotion is affixed, for example, as “I'M A _ FAN.” The object of the fan's devotion or admiration is inserted in the blank in the form of a name, logo, or other image. Enthusiastic fans use the cooling fan as a method of cooling themselves when atmospheric conditions warrant and also to display and profess their devotion to or admiration of a favorite sports team, rock star, band, celebrity, cartoon character, professional sports figure, or the like.

In one exemplary embodiment, the method includes providing a database containing a plurality of images depicting objects of devotion or admiration. The images may include names or logos or both, for a variety of objects of devotion. At least one image is selected from the database of images and printed on an adhesive-backed substrate. The printed image is affixed to the cooling fan in an image-receiving area.

The method can be implemented using any suitable computer system, such as an application server system/client system for transactions over the Internet, or in a stand-alone computer system located at a point of sale.

### DESCRIPTION OF THE DRAWINGS

The invention will be more fully understood from the following detailed description taken in conjunction with the accompanying drawings, in which:

FIG. 1 illustrates a table cooling fan including an image of a fan's object of devotion in accordance with the present invention;

FIG. 2 illustrates an application server system/client system for providing a cooling fan according to the present invention; and

FIG. 3 is a flow chart of a process for purchasing a cooling fan according to the present invention.

### DETAILED DESCRIPTION OF THE INVENTION

The present invention combines two types of “fan.” One type of fan is a device designed to be placed on a table to move air for cooling. The other type of fan is an individual who is an enthusiastic devotee or ardent admirer of a sports team, rock star, rock and roll band, celebrity, cartoon character, race car driver, professional sports figure, or the like.

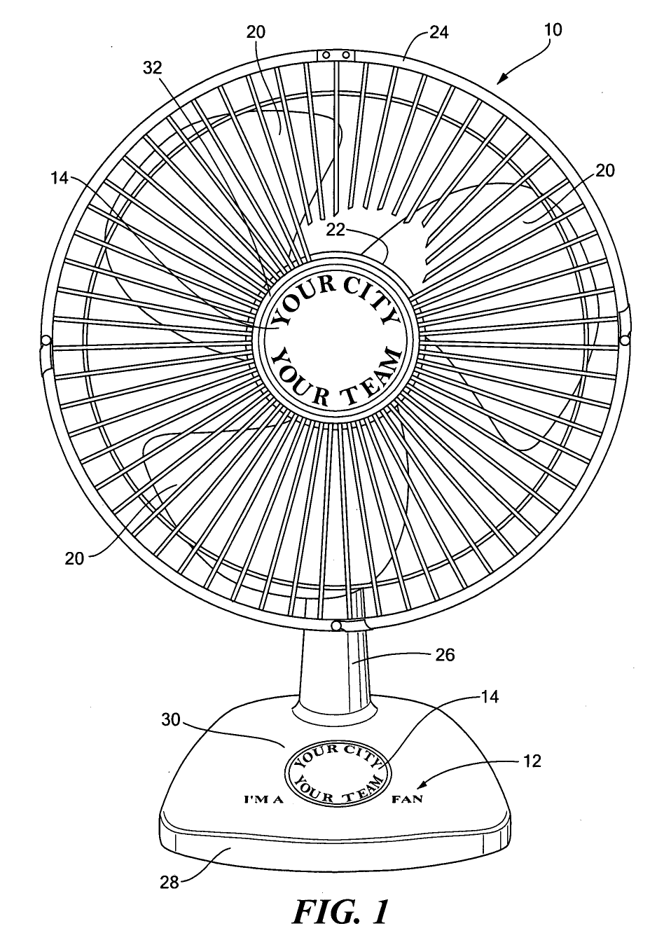

According to the present invention, an enthusiastic fan can express and display his or her devotion as a fan with a phrase(s), logo(s), or other image(s) displayed on a cooling device, also known as a fan. See FIG. 1. More particularly, in one embodiment, an electric table fan 10 includes a statement 12 displayed in a suitable location stating: “I'M A_ FAN.” The object of the fan's devotion is inserted in the blank in the form of a name, logo, or other image. Enthusiastic fans use the table fan as a method of cooling themselves when atmospheric conditions warrant and also to display and profess their devotion to or admiration of a favorite sports team, rock star, band, celebrity, cartoon character, professional sports figure, or the like.

The image can be displayed on the cooling fan in any suitable manner, such as a decal or label 14 adhesively affixed to the image-receiving area of the fan. Any suitable adhesive, preferably a permanent adhesive, can be used. The image can be stored in a computer database of images or uploaded to a suitable computer. The selected image can be printed on a suitable substrate for transfer to the cooling fan. For example, the image can be printed on an adhesive-backed label or decal.

The cooling fan can include the phrase “I'M A” and the word “FAN” previously affixed to the image-receiving area of the fan in any suitable manner, such as by painting, engraving, silk screening, or adhesive label. The image of the object of devotion on the adhesive-backed substrate is then affixed to a space between the phrase “I'M A” and the word “FAN”. Alternatively, the phrase “I'M A” and the word “FAN” can be printed on the adhesive-backed substrate when the image is printed. In a further alternative, the adhesive-backed substrate can include the phrase “I'M A” and the word “FAN” printed thereon prior to printing the name or image of the objection of devotion.

The cooling fan includes fan blades 20 radiating from a hub 22 and enclosed in a protective grill 24. The blades are rotatable by an electric motor in communication with a power source. The hub is mounted on a stem 26 that extends upwardly a suitable distance from a base 28 that rests on a surface, such as a table or floor. In one embodiment, the image is placed in an image-receiving area 30 on the base of the table fan. In another embodiment, the image-receiving area is a circular area 32 at the center of the electric fan's protective grill. Alternatively, the image, or two different images, can be placed in both locations.

The name, logo, or other image of the object of devotion or admiration is selectable based on each individual fan's preference. For example, a Major League Baseball (MLB) fan can show his or her devotion to a favorite baseball team with a table fan stating “I'M A [insert MLB team name or logo] FAN” on the base and/or in the circular area at the center of the fan's protective grill.

Other examples include, but are not limited to, a National Football League (NFL) team; a National Basketball Association (NBA) team; a Women's National Basketball Association (WNBA) team; a National Hockey League (NHL) team; an American Hockey League (AHL) team; a Major League Soccer (MLS) team; a Canadian Football League (CFL) team; a National College Athletic Association (NCAA) team; a National Association of Sports Car Racing (NASCAR) team; a Professional Golf Association (PGA) player; a Ladies Professional Golf Association (LPGA) player; a United States Tennis Association (USTA) player; a cartoon character; a famous rock star; a popular musical band; a celebrity; a science fiction or other type of movie, show, or character; a university; and a branch of the military.

The name, logo, or other image can refer to locally or regionally known organizations or people, such as schools, religious organizations, clubs, places of employment, or family members, such as children, grandchildren, or spouses.

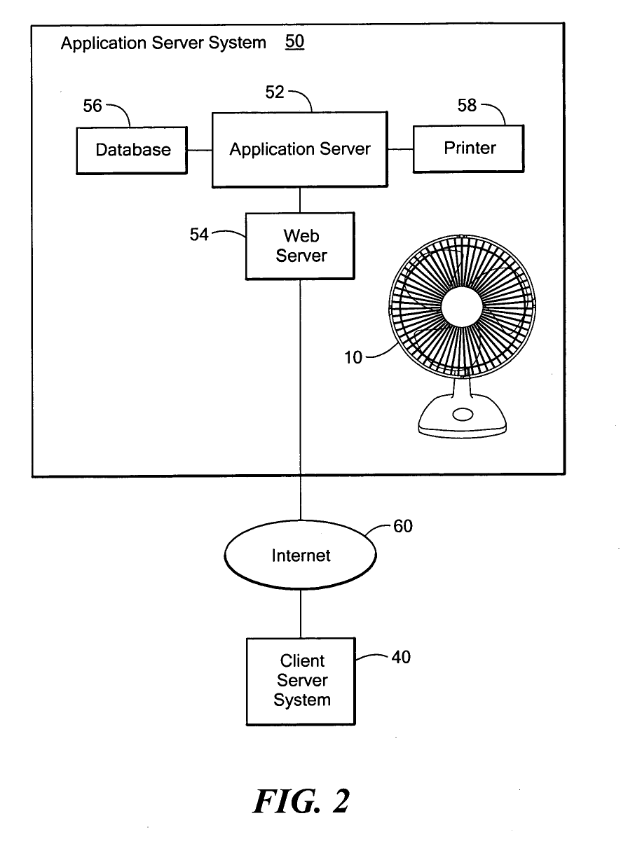

The cooling fan can be purchased through an on-line Internet web site. FIG. 2 illustrates an exemplary embodiment in which a client system 40 and an application server system 50 communicate over the Internet 60 or World Wide Web. For purpose of illustration the Internet may be defined as those resources and users on the Internet using the Hypertext Transfer Protocol (HTTP) to communicate information. Further for purposes of illustration, the client system and the application server system may, for example, consist of personal computers, work stations, Internet appliances, or any other type of hardware platform capable of executing computer software. Accordingly, each of the client system and application server system may include one or more processors, which are communicably coupled to a computer program storage device such as a computer memory, as well as one or more input/output devices. Further for purposes of illustration, the client system includes an Internet browser application program, operable to request data from the application server system responsive to actions performed by a user of the client system.

The application server system includes an application server 52 to provide business services, such as, for example, a graphical user interface. A web server 54 is provided for managing web-based client access to the system. Because data transmitted between the client system and the application server system is often sensitive or confidential, a firewall outside the web server using an authentication and encryption mechanism, such as Secure Socket Layer (SSL), is provided. A database 56 containing names and/or images of objects of devotion is provided in communication with the application server.A printer 58 is provided for printing decals for affixing to a fan 10. Other services, such as email, may be provided, as would be apparent to those of skill in the art.

As noted above, the application server system includes a database containing names, logos or other images of organizations, people, etc., through which a purchaser can browse to select a favorite object of devotion or admiration. The names, logos, and other images can be obtained from various sources. If permission is required and has been obtained for the use of the image, for example, to use a particular logo, such information can be displayed to the user.

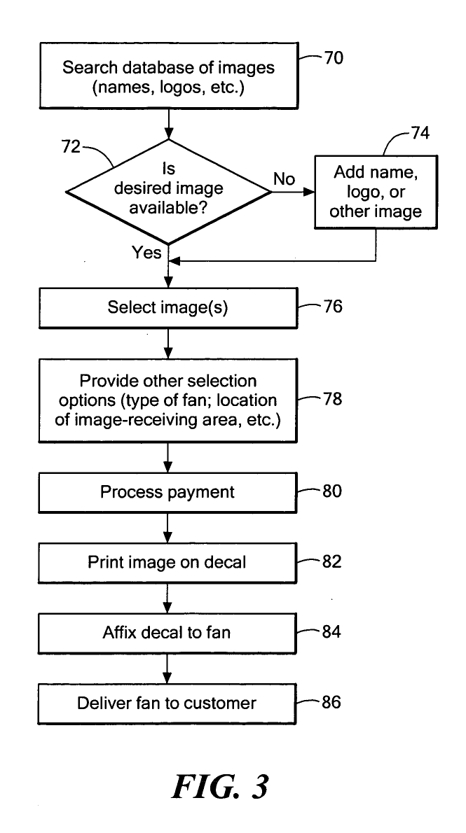

Referring to FIG. 3, in operation, the system allows a purchaser to browse (70) through the database of names, logos, and other images. If a desired name, logo, or other image in unavailable (72), the system can allow the user to enter a name or upload an image to the system (74). After selection of an image(s) (76), the system can offer the purchaser other types of selections (78). For example, the system can also include a database of variety of fan types, sizes, styles, or colors, from which the purchaser can select. The system can allow the purchaser to select the location of the image, such as on the base, on the central area, or both.

Once the object of devotion and the other selections, if available, are selected, the system processes the purchaser's payment for the order, for example, via credit card (80). The system then prints the name or other image on an adhesive decal(s) of the appropriate size (82). The decal(s) is affixed to the selected fan in the desired image-receiving area (84), and the fan is shipped or otherwise delivered to the customer (86). Alternatively, the printed decal(s) can remain unaffixed to the fan during shipment, allowing the purchaser to affix the decal(s) on the fan himself or herself. In a further alternative, a purchaser can purchase only a printed decal for affixation to a preexisting fan or to a fan obtained through another source. In a still further alternative, the purchaser can download the image for printing on a suitable substrate at the purchaser's location.

In an alternative to the client/server application described above, the system can be provided as a stand-alone application. For example, the fans can be sold by a retail outlet, such as a sports shop or souvenir shop associated with a sporting event or locale. A computer system containing a database of names, logos, or other images and a printer capable of printing a selected image on an adhesive decal can be located at the point of sale. A purchaser can select a desired name, logo, or other image from a selection available at the point of sale, and can have the image printed and affixed to a cooling fan at the point of sale. In a still further alternative, a selection of pre-printed names, logos and other images can be provided for user selection and affixation to the cooling fan.

The system can be implemented in any programming language, and any operating system can be used as the platform for development of the user-interface site, as would be known by those of skill in the art. The system may be embodied using a variety of specific data structures. Any suitable cooling fan, such as table-top, floor, or hand-held, can be used with the system. It will be understood that the term table fan as used in the exemplary embodiment described herein does not exclude such various types of fans. Modification to and variation of the illustrated embodiments may be made without departing from the inventive concepts herein disclosed.

What is claimed is:

1. A method for providing cooling fans for displaying an individual fan's object of devotion, comprising:
providing a database containing a plurality of images depicting objects of devotion, the images including names or logos or both;
selecting at least one image from database of images;
printing the selected image on an adhesive-backed substrate;
providing a cooling fan having a plurality of rotatable blades radiating from a hub, a protective grill surrounding the rotatable blades, the hub supported on a base, at least one of the base and the protective grill having an image-receiving area sized to receive the printed image; and
affixing the printed image to the cooling fan in the image-receiving area.

2. The method of claim 1, wherein the database of images is provided in a computer memory of a computer system.

3. The method of claim 1, wherein the database of images is provided in a computer memory of an application server system.

4. The method of claim 3, further comprising allowing a client system to communicate with the application server system over the Internet to select the at least one image.

5. The method of claim 4, further comprising processing payment information for purchase of the cooling fan.

6. The method of claim 4, further comprising providing an authentication and encryption mechanism to protect data transmitted between the client system and the application server system.

7. The method of claim 1, further comprising locating the database of images at a point of sale.

8. The method of claim 1, wherein the cooling fan is provided with the phrase “I'M A” and the word “FAN” in the image-receiving area, with a space disposed between the phrase and the word, the space sized to receive the printed image.

9. The method of claim 1, wherein in the printing step, the selected image is printed in a space on the substrate that includes the phrase “I'M A” and the word “FAN”, the selected image printed between the phrase and the word on the substrate.

10. The method of claim 1, wherein in the printing step, the phrase “I'M A” and the word “FAN” are printed on the substrate with the selected image printed between the phrase and the word.

11. The method of claim 1, wherein the image-receiving area is located on the base of the cooling fan.

12. The method of claim 1, wherein the image-receiving area is located on the protective grill of the cooling fan.

13. The method of claim 1, wherein the image-receiving area is located on the base of the cooling fan and a further image-receiving area is located on the protective grill of the cooling fan.

14. The method of claim 1, further comprising the step of selecting a type of cooling fan.

15. The method of claim 1, wherein the cooling fan comprises a table-top fan.

16. The method of claim 1, wherein the cooling fan comprises a floor fan.

17. The method of claim 1, wherein the cooling fan comprises a hand-held fan.
